(19) United States
(12) Patent Application Publication
(10) Pub. No.: US 2015/0278315 A1
(43) Pub. Date: Oct. 1, 2015

(54) DATA FITTING SELECTED VISUALIZATION TYPE

(71) Applicant: Microsoft Corporation, Redmond, WA (US)

(72) Inventors: Patrick J. Baumgartner, Kirkland, WA (US); Pedram Faghihi Rezaei, Seattle, WA (US); Sharath Kodi Udupa, Seattle, WA (US); Irina Gorbach, Bellevue, WA (US); Adam David Wilson, Seattle, WA (US)

(73) Assignee: Microsoft Corporation, Redmond, WA (US)

(21) Appl. No.: 14/242,607

(22) Filed: Apr. 1, 2014

(51) Int. Cl. G06F 17/30; G06F 3/0484

(52) U.S. Cl. CPC G06F 17/30554; G06F 3/04842; G06F 17/30507

(57) ABSTRACT

A mechanism to visualize data to a user in a sufficient manner. The user selects a visualization type to visualize a selected subset of a data model. To fit the data well into a visualization of that visualization type, the system then evaluates the user selections of the visualization type of the subset of data against the rule set. Based on the evaluation, the system determines that the subset of data does not populate or insufficiently populates the visualization type. In some embodiments, the system further recommends additional data to supplement the selected subset of data to more sufficiently utilize the visualization to display the subset of data in conjunction with the supplemented data. The system may further display the visualization based on the selected subset of the data model perhaps before and/or after supplemented with the supplemented data.

### BACKGROUND

Computing systems have revolutionized the way people communicate, do business, and play, and has enabled what is now termed the “information age”. The Internet may be used to access a wide volume of information, and databases are likewise infused with large quantities of data. However, any given human or entity is not often interested in (or even capable of comprehending) all of the available information at any given time. They often wish to “mine” the information to find those pieces of information that are most relevant to their interests at any given time. However, the task of mining through information can be arduous from an information processing perspective, just as physical mining is arduous from a physical perspective. Furthermore, once the interesting data is obtained, there remains a question of how to most effectively present the resulting data to the user in a manner that the user may intuitively interpret the resulting data.

Visualizations provide a helpful tool whereby information may be presented to humans in a manner that is intuitive to the human mind. There are an enumerable variety of visualization types, each suitable for displaying a particular kind of data. There are bar charts, pie charts, scatter plots, timelines, geographic maps, histograms, Sankey diagrams, Gantt charts, dot distribution maps, contour maps, time series diagrams, bubble charts, stacked graphs, organizational charts, radial trees, dependency graphs, line charts, and enumerable others. Given a certain set of data to be displayed, different visualizations do the job of intuitively conveying information to a human user to different levels of sufficiency.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein provide a mechanism to visualize data to a user in a sufficient manner. The user selects a visualization type to visualize a selected subset of a data model. To fit the data well into a visualization of that visualization type, the system then evaluates the user selections of the visualization type of the subset of data against the rule set. Based on the evaluation, the system determines that the subset of data does not populate or insufficiently populates the visualization type.

In some embodiments, the system further recommends additional data to supplement the selected subset of data to more sufficiently utilize the visualization to display the subset of data in conjunction with the supplemented data. The system may further display the visualization based on the selected subset of the data model perhaps before and/or after supplemented with the supplemented data.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing system in which the principles described herein may be employed;

FIG. 2 illustrates a system that may represent an architecture that runs in the context of a computing system such as, for example, the computing system of FIG. 1;

FIG. 3 illustrates a flowchart of a method for using a computing system to visualize selected data using a visualization of a selected visualization type within computing system;

FIG. 4 illustrates a method that may be performed after the method of FIG. 3 and while there is a recommendation of one or more data sets being displayed to the user;

FIG. 5 illustrates a bar chart visualization that might be displayed after a user selects data that includes a count of flights by airline, and selects a bar chart visualization; and

FIG. 6 illustrates a map visualization that might be displayed after the user switches from FIG. 5 to a map visualization, and further accepts a recommendation to have geo-codable data added to the selected data for visualization.

### DETAILED DESCRIPTION

At least some embodiments described herein provide a mechanism to visualize data to a user in a sufficient manner. The user selects a visualization type to use to visualize a selected subset of a data model. To fit the data well into a visualization of that visualization type, the system then evaluates the user selections of the visualization type of the subset of data against the rule set. Based on the evaluation, the system determines that the subset of data does not populate or insufficiently populates the visualization type.

In some embodiments, the system further recommends additional data to supplement the selected subset of data to more sufficiently utilize the visualization to display the subset of data in conjunction with the supplemented data. The system may further display the visualization based on the selected subset of the data model perhaps before and/or after supplemented with the supplemented data.

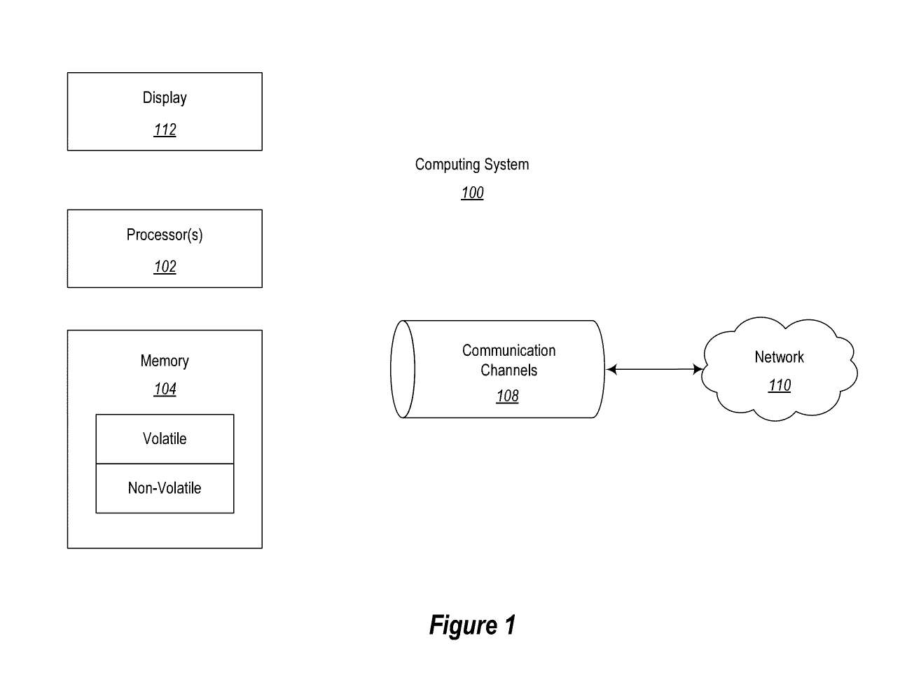

Some introductory discussion of a computing system will be described with respect to FIG. 1. Then, example user interfaces, methods and supporting architectures will be described with respect to subsequent figures.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “executable module” or “executable component” can refer to software objects, routines, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110. The computing system 100 also includes a display 112 for displaying user interfaces such as those described herein.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other tangible medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

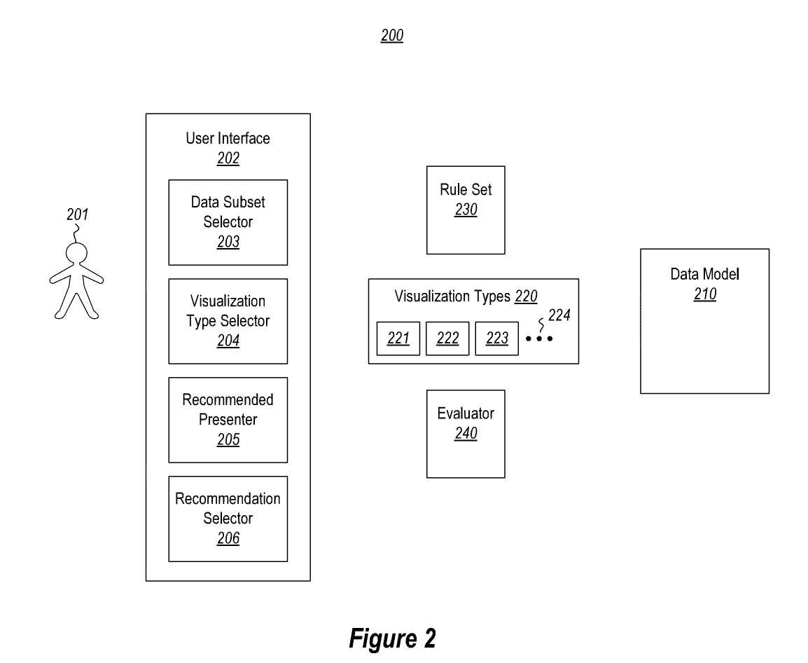

FIG. 2 illustrates a system 200 that may represent an architecture that runs in the context of a computing system such as, for example, the computing system 100 of FIG. 1. The various element illustrated in the system 200 may be software, hardware, firmware, or a combination thereof.

The system 200 includes a data model 210 that provides access to a set of data items that are interrelated and defines the relationship between the set of data items. That data model 210 is further capable of receiving queries, interpreting queries, and responding to the queries with selected data. The data model 210 may be an authored data model in which case a data model author defines the relationship between the data. The data model 210 may also be an authored data model that has been expanded one or more times with various auxiliary information data not originally within the authored data model. Accordingly, the term “data model”, as used within this description and in the claims, is to be interpreted broadly.

The data model 210 may include voluminous amounts of data. A user 201 may query into the data model 210 by interacting the data model 210 via a user interface 202 to thereby select a subset of the available data to retrieve. For instance, the user 201 may interact with a data subset selector 203 to thereby form the appropriate query to retrieve the selected data from the data model.

As mentioned previously, the amount of data that is included in any given data model 210 may be quite voluminous. Accordingly, the system 200 includes a set of visualization types 220 that may be used to visualize a variety data on the user interface. The user 201 may interact with the user interface 202 via a visualization type selector 204 to thereby select which visualization type is to be used when presenting the selected data to the user 201.

Such variety of visualization types is helpful as any given visualization type is most suitable for expressing certain types of data and certain collections of related data. The visualization types 220 are abstractly illustrated as displaying three visualization types 221, 222 and 223, although the ellipses 224 represents that there may be a different number of visualization types. There may be hundreds or even thousands of visualization types available within the system. Examples of visualization types that may be within the visualization types 220 include a scatter plot, a bar chart, a timeline, a pie chart, a map, a geographic map, a histogram, a Sankey diagram, a Gantt chart, a dot distribution map, a contour map, a time series, a bubble chart, a stacked graph, an organizational chart, a radial tree, a dependency graph, a line chart, and enumerable others. The number of available visualization types is growing as individuals conceive of different ways to visualize data of particular types to humans in an intuitive way.

The system 200 also includes a rule set 230 and an evaluation component 240. The evaluator 240 may compare the selected data and the selected visualization type against the rule set 230 to determine the sufficiency of the visualization type to intuitively present the selected data. “Sufficiency” is a term that is often used in the art to quantify the suitability of a visualization type to present certain data or a certain collection of data to a human user in a manner that can be intuitively interpreted by a human user.

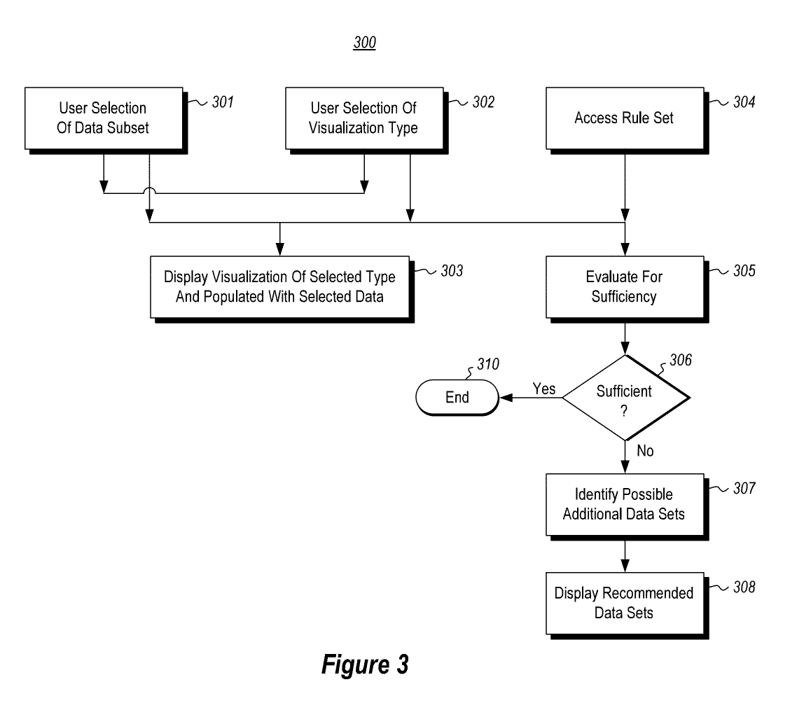

FIG. 3 illustrates a flowchart of a method 300 for using a computing system to visualize selected data using a visualization of a selected visualization type within computing system. The method 300 may be performed, for example, using the system 200 of Figure in, for example, the computing system 100 of FIG. 1.

The user selects a subset of data from a data model, which user selection is then accessed by the computing system (act 301). For instance, in the context of FIG. 2, the user 201 may interact with the data selector 203 of the user interface 202 to formulate a query to submit to the data model 210.

The user also selects a visualization type of the available visualization types, which user selection is then accessed by the computing system (act 302). For instance, in FIG. 2, the user 201 may interact with the visualization selector 204 to select one of the visualization types 220.

Optionally, once the selected data is retrieved in response to the user selecting the data (act 301), and the visualization type is properly selected (act 302), a visualization of the selected visualization type is then displayed using the selected subset of data from the data model (act 303). For instance, in the context of FIG. 2, after the query form from the selected data is formed, submitted to the data model 210, and the data model 210 returns the resulting data, the user interface 202 may then formulate the visualization.

The acts 301 and 302 are shown in parallel in the flowchart of the method 300 to emphasize that there is not necessarily any temporal dependency between when the user selects the data (act 301) and the visualization type (act 302), although various implementations may impose such a temporal dependency. However, more generally speaking, the user may select the data before, after, and/or during the time that the user selects the visualization type.

The method 300 also includes accessing a rule set (act 304) that may be used to determine sufficiency of any of a given visualization type (e.g., the selected visualization type) to display given data (including the selected data) in a manner that may be visually interpreted by a human user. For instance, in FIG. 2, the evaluator 240 may access the rule set 230 to determine the sufficiency of the visualization type selected by the user via the visualization selector 204 for displaying (via the user interface 202) data selected by the user via the data selector 203 in a manner to be intuitively interpreted by a human user.

The accessing of the rule set (act 304) is shown in parallel with acts 301, 302 and 303 to symbolize that in the most general sense, there is no temporal dependency between when the rule set is accessed, and when the user selected the data set and the visualization type, and the optional display of the visualization using the original data set.

After the user selection of the data set is accessed (act 301), the user selection of the visualization type is accessed (act 302), and the rule set is accessed (act 304), the rule set is then evaluated (act 305), along with the user selections of the selected visualization type and the selected data, to determine the sufficiency (also act 305) of the selected visualization type to display the selected data.

The system then determines whether the selected visualization type is sufficient to display the selected data (decision block 306). If the visualization type is determined to be sufficient to display the selected data (“Yes” in decision block 306), then the method may end (act 310). Recall previously, however, that the display of a visualization (act 303) of the selected visualization type using the original selected data is optional. It may be that that visualization is not displayed before the system determines that the visualization of that selected visualization type is sufficient in decision block 306. If that is the case, then the visualization may then be displayed (act 303) based on the originally selected data.

On the other hand, if the sufficiency of the visualization type is not adequate (either because the selected data cannot be used to populate the visualization of the selected visualization type, or because the selected data only insufficiently populates the visualization of the selected visualization type), then the system determines that that the subset of data does not populate or “insufficiently populates” the visualization type. The system then determines (act 307) which one or more additional data sets from the data model may be used to improve the sufficiency of the visualization type for displaying the selected data (along with the additional data set). For instance, in FIG. 2, the determination of the sufficiency (decision block 306) and the determination of one or more additional data sets might increase sufficiency (act 307) may be performed by the evaluator 240.

The system then recommends (act 308) one or more additional data sets from the data model that would, according to the rule set, be more sufficient to populate the selected visualization type. For instance, in the context of FIG. 2, the recommendation presenter 205 may present the recommendations of the additional data sets to the user 201. The method 300 may then end, perhaps leaving method 400 to be performed when the user selects one of the recommend additional data set(s).

When recommending one or more additional data sets to supplement the originally requested data sets, the system may sort the resulting recommended data sets in ranked fashion. For instance, the results may be ranked by any one or a combination (perhaps a weighted combination) of the following: frequency of use by all or multiple users, frequency of use by the current user, frequency of use by all or multiple users with the currently selected visualization type, frequency of use by the current user with the currently selected visualization type, amount of information entropy introduced or removed, resulting improvement in sufficiency, alphabetical, or the like.

The method 300 may be performed multiple times, each time the user selecting a data set and a visualization type. In some embodiments, the user may simply switch the selected visualization type and keep that data the same. In that case, the method 300 would be performed to perform the switch. However, the user would only explicitly select the visualization type (act 302) to be switched to. The user implicitly selects the data (act 301) as being the same data that was being used to render the prior visualization at the time of the switch.

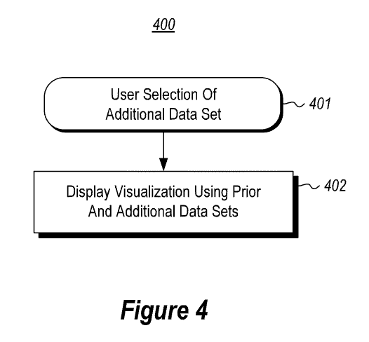

FIG. 4 illustrates a method 400 that may be performed after the method 300 is performed and while there is a recommendation of one or more data sets being displayed to the user (which was initiated in act 308). The method 400 is initiated upon the system detecting a user selection of at least one of the one or more recommended additional data sets (act 401). For instance, in FIG. 2, the user may have interacted with the recommendation selector 206 to thereby select one or more of the recommended data sets displayed in the recommendation presenter 205.

In response, the system displays the visualization of the selected visualization type using the selected subset of data from the model, and using the selected additional recommended data set(s) (act 402). For instance, in the context of FIG. 2, after the system formulates an additional query to the data model 210 for the selected additional recommend data set(s), the results of the additional query are then used (in conjunction with the original query) to formulate a revised visualization of the selected visualization type. Some implementations may then return to the decision block 306 of FIG. 3 to again evaluate the sufficiency of the aggregated data. Accordingly, there may be multiple phases of visualizing the visualization, and aggregating additional data into the visualization, until the user gets an intuitive view into the data.

Now that general embodiments have been described with respect to FIGS. 2 through 4, some very specific scenarios will now be described with respect to subsequent figures. Such specific scenarios should not be construed as limiting the more general principles described herein. The scenarios are presented merely to illustrate how useful the principles described herein may be to a user who desires to get an intuitive view on selected data.

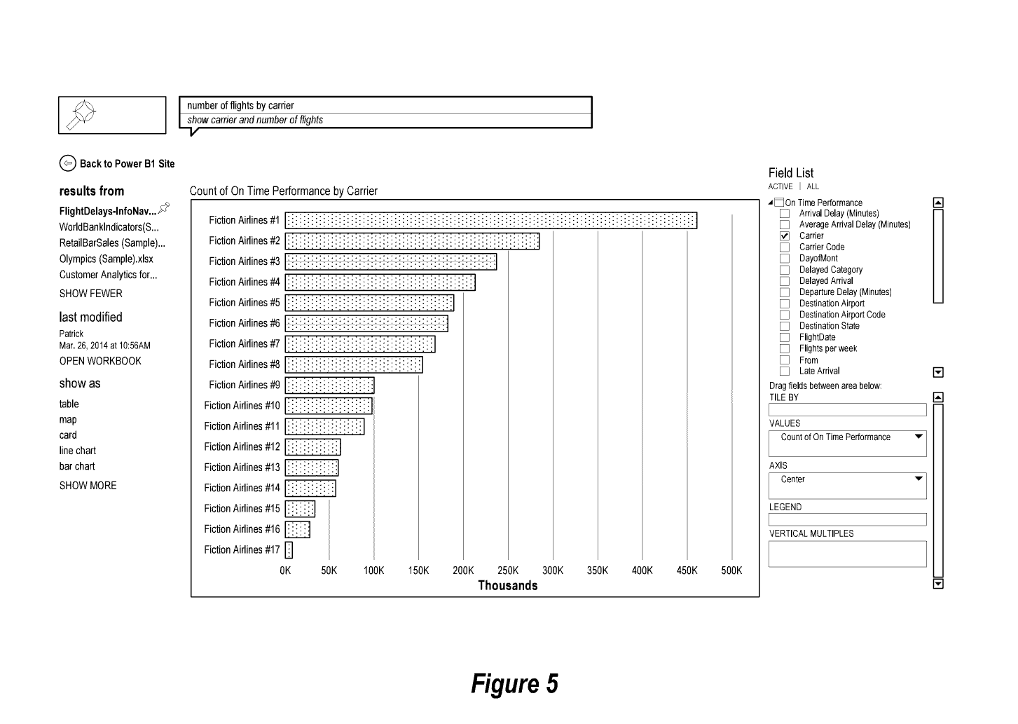

Suppose that the use selects data from a data model, the selected data including the number of flights in a given year by name of the airline. Suppose further that the user selects a bar chart as a visualization type. FIG. 5 illustrates a visualization that might be displayed (e.g., in act 303 of FIG. 3, or after “Yes” in decision block 306) in response. Here, each bar is assigned to an airline (a fictionally named airline), and the length of the bar represents the associated number of flights for that airline. Note that the selected data has a high sufficiency for the selected bar chart visualization type, as the information is presented in a manner that is highly intuitive for human interpretation. After all, bar charts are helpful and intuitive where the data includes a limited number of categories (one bar being assignable to each category) and with each category having an associated count or amount (represented by the length of the associated bar).

However, suppose another scenario in which the user selected again the same data (i.e., number of flights by airline) but chose instead a map visualization. For instance, the user might have initially selected this visualization type using the selected data. Alternatively, the user may have simply selected the map visualization type when the user was reviewing the bar chart visualization of FIG. 5, thereby essentially switching visualizations.

It is difficult to determine how to visualize the selected data using that selected map visualization. After all, maps are helpful for displaying data that is geo-codable, and there is no geo-codability in a listing of airlines with associated flight counts. Accordingly, referring to FIG. 3, the system might attempt to display the visualization (in act 303) by perhaps just showing the map visualization with no sample points. However, the decision block 306 would result in a determination that the selected data is not sufficient for display in the map visualization (“No” in decision block 306). Thus, the system might identify additional data sets (perhaps those data sets that involve geo-coding in this case) that would improve the sufficiency of the data for the map visualization.

Now suppose that there is an additional data set that identifies, for any given flight, where the flight originated from. Such a data set identifier may be presented in the recommended list of data sets (in act 308). When the user selects this recommended data set (in act 401), the additional flight origination data is retrieved, merged with the original data, and the corresponding visualization is updated (in act 402).

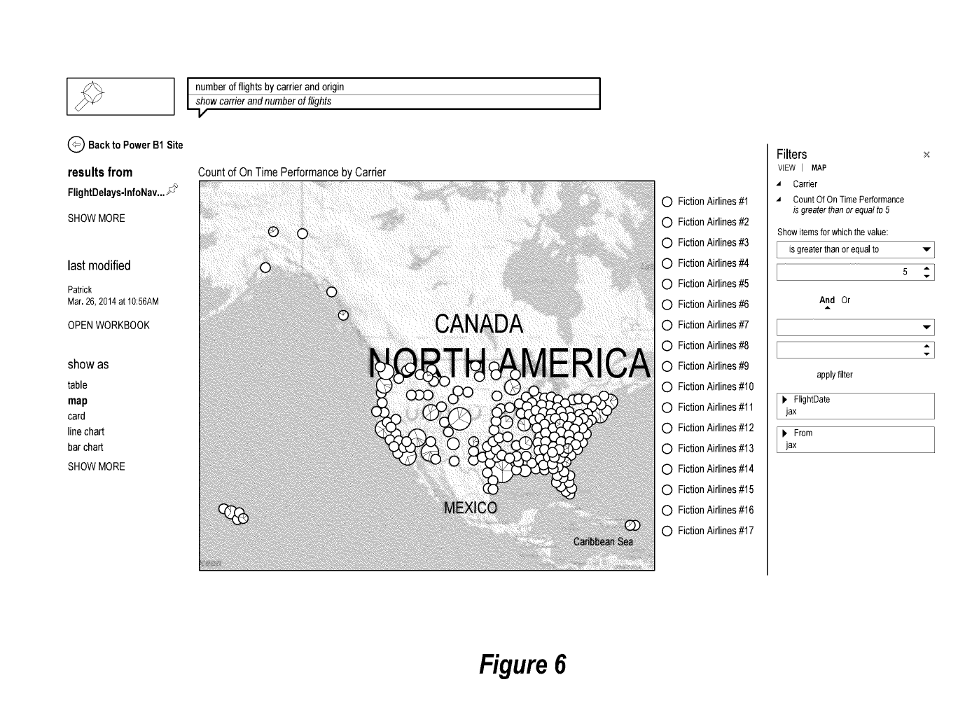

For instance, FIG. 6 illustrates a user interface in which the map visualization is now populated with the original data supplemented by the flight origination data. The map visualization includes many mini pie charts, each pie chart corresponding to a location from which any of the flights originated. The size of the pie chart is sized in proportion to the number of flights originating from that location. Furthermore, the pie chart shows slices by airline, so as to show the proportion of flights from various airlines originating from that location. Thus, FIG. 6 illustrates a much more intuitive and informative view on the originally requested data, as supplemented by the additional data set. Thus, the user was able to stay with the selected visualization type, even though the original requested data did not fit well within that visualization type.

A second, lengthier, scenario will now be described. Suppose the user first selects as data the number of sales for different products from a database. The database contains products, their orders, their customers, and the employees selling the products along with the details for each of these entities. Suppose the user first selects to display the number of sales for different products in a bar chart visualization. A bar chart visualization is a good visualization for the selected data which includes a limited set of categories (i.e., products) each assignable to a bar, as well as a count or amount associated with each (corresponding to the length of each bar).

Now suppose the user changes the visualization type from a bar chart to a map visualization. Again, the best data for a map visualization would include a geo-codable field, so that the data could be charted spatially on the map. A map visualization might also use a minimum or maximum number of measures and fields and overall rows of data supported by the visualization.

If the system then evaluates the currently selected data for sufficiency, the system recognizes that there is no geo-codable field. Based on this evaluation, the system looks for a geo-codable field in the database from which the data is being visualized. As an example, the system might find a “Sales Location” field in the database that is geo-codable.

Next, for this example, suppose that number of combinations between products and sales locations exceeds the number of data points that are supported by the selected map visualization. To account for this, the system might attempt to look for a different geo-codable field (such as “sales state”) and evaluated to see if it can be rendered by the data visualization. If no such field is found, a filter can be placed on the selected measure (sales amount) to reduce the number of data points that need to be charted. For instance, a filter for “sales amount greater than 5” would remove all locations with fewer than 6 sales, thus bringing the number of points to chart within the capabilities of the specific map visualization.

Now suppose the user changes the map visualization to a table visualization. The system then evaluates the most sufficient data to use in the table visualization. The table visualization can display any number of fields up to a number of columns suitable for the current display. In this case, assume the user has a small monitor and can only display 9 columns. Furthermore, assume that the current display can display an unlimited number of rows.

The current map visualization only has 3 columns of data, so the system would search the database for the “best” related columns to add to the visualization based on the database structure and metadata. In this case, assume that the system found the following columns of data (unfiltered): Product Name, Sales Amount, Sales Date, Customer Name, Sales City, Sales State, Sales Country, Sales Person Name, Product Supplier Name. A column is selected for each of these additional data sets, since there are nine data categories, and that a column can be dedicated for each category.

Now suppose the user changes change the table visualization to a line chart. The system evaluates the “best data” to use in the selected line chart visualization, and determines that the line chart visualization is suitable for displaying a limited number of fields and measures (1 to 10 measures and 2 to 3 fields) in an understandable manner. Since the table has more measures and fields than can be suitably displayed in this line chart, the system evaluates which columns are the best to keep and the best to remove. Using a set of rules describing the sufficiency for line charts, the system might select the following fields for display in the line chart: 1) Select a time series based data if available for the x axis: in this case Sales Date, 2) Select up to n measures (where n is defined by the upper limit for the chart rendering provider) for the y axis: in this case only “Sales Amount”, and 3) Select the most suitable identifier for the set of data based on database metadata to use as a color-coded legend for the lines: Product Name

Next, the system check to see if a low cardinality column exists, which could be used to break the line chart into small-multiple line charts (e.g. repeat the line chart multiple times for different entity values). For instance, suppose there are 4 customer names. The original line chart may thus be broken into 4 small line charts (one for each customers).

A similar analysis may repeat (evaluate the best data to use for the new visualization type) whenever the user changes the selected visualization against the current data set, or changes the current data set. Accordingly, the principles described herein provide an effective technique for fitting data to visualizations by augmenting the originally selected data set. Thus, visualizations may be used to display more types of data, perhaps after the selected data is augmented.

In the described embodiments, the system recommends additional data sets, which the user then selects. However, the principles described herein may also perform this process automatically by simply modifying the data set to populate the visualization type without user input.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method comprising:
an act of accessing a user selection of a visualization type;
an act of accessing a user selection of a subset of data from a data model;
an act of evaluating the user selections of the visualization type and the subset of data against a rule set that defines sufficiency of data for the selected visualization type; and
based on the evaluation, an act of determining that the subset of data does not populate or insufficiently populates the visualization type.

2. A method in accordance with claim 1, further comprising:
an act of displaying a visualization of the selected visualization type using the selected subset of data from the data model.

3. A method in accordance with claim 1, further comprising:
an act of recommending one or more additional data sets from the data model that would, according to the rule set, be more sufficient to populate the selected visualization type.

4. A method in accordance with claim 3, further comprising:
an act of detecting a user selection of at least one of the one or more recommended additional data sets.

5. A method in accordance with claim 4, further comprising:
an act of displaying a visualization of the selected visualization type using the selected subset of data from the model, and using the at least one recommended additional data set.

6. A method in accordance with claim 1, the data model being an authored data model.

7. A method in accordance with claim 6, the authored data model further being expanded with auxiliary information not originally within the authored data model.

8. A method in accordance with claim 1, the rule set defining sufficiency data for each of a plurality of visualization types.

9. A method in accordance with claim 8, the user selection of the visualization type being a first user selection of a first visualization type, the user selection of the subset of data being a first user selection of a first subset of the data, and the comparison being a first comparison, the method further comprising:
an act of accessing a second user selection of a second visualization type;
an act of accessing a second user selection of a second subset of data from the data model;
an act of evaluating the second user selection of the second visualization type and the second selection of the second subset of data against the rule set using sufficiency of data for the second visualization type; and
based on the second comparison, an act of determining that the second subset of data does not populate or “insufficiently populates” the second visualization type.

10. A method in accordance with claim 9, the second subset of data being the same as the first subset of data.

11. A method in accordance with claim 10, the method further comprising:
an act of displaying a visualization of the first selected visualization type using the first selected subset of data from the data model,
the act of accessing a second user selection of the second visualization type comprising:
an act of accessing a user request to switch from the first visualization type to the second visualization type at some point.

12. A method in accordance with claim 1, wherein the subset of data does not populate the visualization type.

13. A method in accordance with claim 1, wherein the subset of insufficiently populates the visualization type.

14. A computer program product comprising one or more computer-readable storage media having thereon one or more computer-executable instructions that are structured such that, when executed by one or more processors of the computing system, cause the computing system respond to a user selection of a visualization and a user selection of a subset of data from the data model by performing the following:
an act of accessing a rule set that defines sufficiency of data for the selected visualization;
an act of evaluating the user selections of the visualization type and the subset of data against the rule set;
based on the evaluation, an act of determining that the subset of data does not populate or insufficiently populates the visualization type; and
an act of displaying a visualization of the visualization type.

15. A computer program product in accordance with claim 14, the visualization type being a scatter plot.

16. A computer program product in accordance with claim 14, the visualization type being a geographic visualization.

17. A computer program product in accordance with claim 14, the visualization type being a bar chart.

18. A computer program product in accordance with claim 14, the visualization type being a timeline.

19. A computer program product in accordance with claim 14, the visualization type being a pie chart.
method in accordance with claim 1, further comprising:
an act of displaying a visualization of the selected visualization type using the selected subset of data from the data model.

20. A computer program product comprising one or more computer-readable storage media having thereon one or more computer-executable instructions that are structured such that, when executed by one or more processors of the computing system, cause the computing system respond to a user selection of a visualization and a user selection of a subset of data from the data model by performing the following:
an act of accessing a rule set that defines sufficiency of data for the selected visualization;
an act of evaluating the user selections of the visualization type and the subset of data against the rule set;
based on the evaluation, an act of determining that the subset of data does not populate or insufficiently populates the visualization type;
an act of recommending one or more additional data sets from the data model that would, according to the rule set, be more sufficient to populate the selected visualization type; and in response to detecting a user selection of at least one of the one or more recommended data sets, an act of displaying a visualization of the selected visualization type using the selected subset of data from the model, and using the at least one recommended additional data set.

21. A system for a computer architecture comprising:
one or more processors;
an interface;
a memory containing computer-executable instructions which, when executed by the one or more processors perform a computer-implemented which comprises:
at the interface, using a visualization type selector to select one visualization type from among a plurality of available visualization types;
at the interface, using a data subset selector to select a first subset of data from a stored data model;
the one or more processors then accessing a stored rule set and using the stored rule set to perform an evaluation of the selected one visualization type and the selected first subset of data to determine whether the selected first subset of data is sufficient for display using the selected visualization type;
based on the evaluation, the one or more processors determining that the selected first subset of data does not populate or insufficiently populates the selected one visualization type; and
the one or more processors then using the rule set to determine either a new visualization type or a new subset of data, or both, that provide sufficient population of at least one of the plurality of visualization types.

22. The system of claim 21, wherein the determination of either a new visualization type or a new subset of data, or both, that provide sufficient population of at least one of the plurality of visualization types comprises, at the interface, using the visualization type selector to select a different visualization type from among the plurality of available visualization types that will permit sufficient population of the different visualization type using the selected first subset of data.

23. The system claim 21, wherein the determination of either a new visualization type or a new subset of data, or both, that provide sufficient population of at least one of the plurality of visualization types comprises, at the interface, using a recommendation selector to select a recommended second subset of data from the stored data model, wherein the recommended second subset of data provides sufficient population of the selected one visualization type either alone or in combination with the selected first subset of data.

24. The system of claim 21, wherein the determination of either a new visualization type or a new subset of data, or both, that provide sufficient population of at least one of the plurality of visualization types comprises, at the interface,
using the visualization type selector to select a different visualization type from among the plurality of available visualization types, and
using a recommendation selector to select a recommended second subset of data from the stored data model, wherein the recommended second subset of data provides sufficient population of the selected different visualization type either alone or in combination with the selected first subset of data.
